(19) United States
(12) Patent Application Publication
(10) Pub. No.: US 2024/0403125 A1
(43) Pub. Date: Dec. 5, 2024

(54) METHOD, DEVICE, AND MEDIUM FOR PLACING INFORMATION

(71) Applicants: LEMON INC., Grand Cayman (KY); BEIJING YOUZHUJU NETWORK TECHNOLOGY CO., LTD., Beijing (CN)

(72) Inventors: Yuanlong CHEN, Los Angeles, CA (US); Bowen ZHU, Los Angeles, CA (US); Bing XIA, Beijing (CN); Yichuan WANG, Los Angeles, CA (US); Reza MADAD, Los Angeles, CA (US); Xudong ZHANG, Beijing (CN); He XIAO, Beijing (CN)

(21) Appl. No.: 18/803,132

(22) Filed: Aug. 13, 2024

(51) Int. Cl. G06F 9/50

(52) U.S. Cl. CPC G06F 9/5027

(57) ABSTRACT

Embodiments of the present disclosure provide a method, device, and medium for placing information. The method comprises obtaining a plurality of pairs of consumption limits and actual consumptions within a period of time, where the consumption limits in the plurality of pairs are not monotonic in a case that the plurality of pairs are sorted by actual consumptions. The method further comprises adjusting the consumption limits in the plurality of pairs such that the adjusted consumption limits are monotonic in the case that the plurality of pairs are sorted by the actual consumptions. In addition, the method further comprises allocating a target consumption limit for placement of target information based on the adjusted plurality of pairs of consumption limits and actual consumptions.

### BACKGROUND

With the development of digital technology, effectively managing the placement of information and the associated resource utilization is crucial for achieving optimal results. This process involves strategically determining where and how to present information, setting limits on resource allocation, and tracking actual resource usage.

Determining an optimal resource consumption limit based on historical pairs of resource consumption limits and actual resource consumptions and a given budget involves analyzing past data to understand the relationship between resource consumption limits and the resulting actual resource consumptions. This helps in making an informed decision that maximizes effectiveness while staying within an expected resource consumption.

### SUMMARY

In a first aspect according to some embodiments of the present disclosure, a method for placing information is provided. The method comprises obtaining a plurality of pairs of consumption limits and actual consumptions within a period of time, where the consumption limits in the plurality of pairs are not monotonic in a case that the plurality of pairs are sorted by actual consumptions. The method further comprises adjusting the consumption limits in the plurality of pairs such that the adjusted consumption limits are monotonic in the case that the plurality of pairs are sorted by the actual consumptions. In addition, the method further comprises allocating a target consumption limit for placement of target information based on the adjusted plurality of pairs of consumption limits and actual consumptions.

In a second aspect according to some embodiments of the present disclosure, an electronic device comprising a memory and a processor is provided. The memory is configured to store computer instructions which, when executed by the processor, cause the processor to obtain a plurality of pairs of consumption limits and actual consumptions within a period of time, where the consumption limits in the plurality of pairs are not monotonic in a case that the plurality of pairs are sorted by actual consumptions. The instructions further cause the processor to adjust the consumption limits in the plurality of pairs such that the adjusted consumption limits are monotonic in the case that the plurality of pairs are sorted by the actual consumptions. In addition, the instructions further cause the processor to allocate a target consumption limit for placement of target information based on the adjusted plurality of pairs of consumption limits and actual consumptions.

In a third aspect according to some embodiments of the present disclosure, a non-transitory computer-readable medium is provided. The medium comprises instructions stored thereon which, when executed by a processor, cause the processor to obtain a plurality of pairs of consumption limits and actual consumptions within a period of time, where the consumption limits in the plurality of pairs are not monotonic in a case that the plurality of pairs are sorted by actual consumptions. The instructions further cause the processor to adjust the consumption limits in the plurality of pairs such that the adjusted consumption limits are monotonic in the case that the plurality of pairs are sorted by the actual consumptions. In addition, the instructions further cause the processor to allocate a target consumption limit for placement of target information based on the adjusted plurality of pairs of consumption limits and actual consumptions.

Any of the one or more above aspects in combination with any other of the one or more aspects. Any of the one or more aspects as described herein. This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Embodiments of the present disclosure may be understood from the following Detailed Description when read with the accompanying figures. In accordance with the standard practice in the industry, various features are not drawn to scale. In fact, the dimensions of the various features may be arbitrarily increased or reduced for clarity of discussion. Some examples of the present disclosure are described with reference to the following figures.

FIG. 1 illustrates an example environment in which example embodiments of the present disclosure may be implemented;

FIG. 2 is a flow chart illustrating an example process of placing information according to some embodiments of the present disclosure;

FIG. 3 is a flow chart illustrating another example process of placing information according to some embodiments of the present disclosure;

FIGS. 4A-4B are schematic diagrams illustrating an example of adjusting a plurality of pairs of consumption limits and actual consumptions according to some embodiments of the present disclosure;

FIGS. 5A-5B are schematic diagrams illustrating an example of adjusting a plurality of pairs of consumption limits and actual consumptions with weights according to some embodiments of the present disclosure;

FIG. 6 is a schematic diagram illustrating an example of generating a fitting function of consumption limit and actual consumption based on the adjusted plurality of pairs of consumption limits and actual consumptions according to some embodiments of the present disclosure; and

FIG. 7 is a block diagram illustrating physical components (for example hardware) of an electronic device with which aspects of the present disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects may be practiced as methods, systems or devices. Accordingly, aspects may take the form of a hardware implementation, an entirely software implementation, or an implementation combining software and hardware aspects. The following detailed description is therefore not to be taken in a limiting sense, and the scope of the present disclosure is defined by the appended claims and their equivalents. A plurality of steps recorded in method implementations in the present disclosure may be performed in different orders and/or in parallel. In addition, additional steps may be included and/or the execution of the illustrated steps may be omitted in the method implementations. The scope of the present disclosure is not limited in this aspect.

The term “including” used herein and variations thereof are an open-ended inclusion, namely, “including but not limited to”. The term “based on” is interpreted as “at least partially based on”. The term “an embodiment” means “at least one embodiment”; the term “another embodiment” means “at least one additional embodiment”; and the term “some embodiments” means “at least some embodiments”. The related definitions of other terms will be provided in the subsequent description. Concepts such as “first” and “second” mentioned in the present disclosure are only for distinguishing different apparatuses, modules, or units, and are not intended to limit the order or relation of interdependence of functions performed by these apparatuses, modules, or units. Variants of “one” and “a plurality of” mentioned in the present disclosure are illustrative and not restrictive, and those skilled in the art should understand that unless otherwise explicitly specified in the context, the modifiers should be understood as “one or more”. The names of messages or information exchanged between apparatuses in the implementations of the present disclosure are provided for illustrative purposes only, and are not used to limit the scope of these messages or information. Data (including the data itself, and data acquisition, or usage) involved in the technical solutions should comply with the requirements of corresponding laws and regulations, and relevant stipulations.

Information placement refers to the strategic positioning of information to reach the desired audience effectively. This involves choosing the appropriate platforms, timing, and formats to ensure that the message resonates with and engages the target audience. Effective information placement can maximize the efficient of information delivery while staying within an expected resource consumption.

A consumption limit is a limit of resources allocated for placing information once. This consumption limit is set based on various factors. By setting a consumption limit, organizations can control and optimize the allocation of their resources, ensuring that they achieve the best possible results without exceeding their capabilities.

An actual consumption refers to the actual usage of resources during a period of time (e.g., 20 seconds or 30 seconds, etc.). This involves monitoring and analyzing the resources spent to ensure they align with the set limits and the overall campaign strategy. Understanding actual resource consumption helps in evaluating the efficiency and effectiveness of the resource allocation.

An expected consumption is the planned amount of resources to be utilized in a period of time. This involves estimating the necessary resources required to achieve the desired outcomes and setting a plan to ensure these resources are available and used efficiently. Proper planning of expected consumption helps in maintaining a balanced approach and avoiding resource shortages or overspending.

When a user places information in an application or a platform, the user may provide an expected consumption for a period of time to the platform. After receiving a request to placing the information, the platform may determine a target consumption limit based on the expected consumption and historical data including consumption limits and actual consumptions, such that the expected consumption can be used in an efficient and effective way, and the audience engagements can be maximized.

In some traditional schemes, a machine learning module may be trained to predict the target consumption limit based on the historical dataset. However, the platform environment is changing all the time, such that the machine learning model trained on stale historical data cannot accurately predict the target consumption limit.

In some traditional schemes, after receiving a request to placing the information, the platform collects a plurality of pairs of consumption limits and actual consumptions. The platform filters the data to find a longest increasing subsequence (LIS) from the plurality of pairs of consumption limits and actual consumptions. To ensure the monotonicity property, the violators (i.e., the data causing the sequence to be non-monotonic) are discarded. However, the information indicated by the discarded violators, which is useful for determining the target consumption limit, is also discarded, leading to low accuracy of the determined target consumption limit. In addition, more than one longest increasing subsequences may be exist in the plurality of pairs of consumption limits and actual consumptions. Thus, a plurality of target consumption limits may be determined based on the plurality of subsequences, leading to poor stability of the target consumption limit.

Therefore, the embodiments of the present disclosure provide a scheme for placing information. In the provided scheme, a computing device may obtain a plurality of pairs of consumption limits and actual consumptions within a period of time, where the consumption limits in the plurality of pairs are not monotonic in a case that the plurality of pairs are sorted by actual consumptions. Then, the computing device may adjust the consumption limits in the plurality of pairs such that the adjusted consumption limits are monotonic in the case that the plurality of pairs are sorted by the actual consumptions. After obtaining the adjusted plurality of pairs of consumption limits and actual consumptions, the computing device may allocate a target consumption limit for placement of target information based on the adjusted plurality of pairs of consumption limits and actual consumptions.

In this way, the target consumption limit can be determined in real-time based on the fresh data. Furthermore, by adjusting the pairs violating the monotonic property, all information indicated in the plurality of pairs of consumption limits and actual consumptions can be leveraged for determining the target consumption limit. Thus, the effective and the accuracy of the determined target consumption limit can be improved.

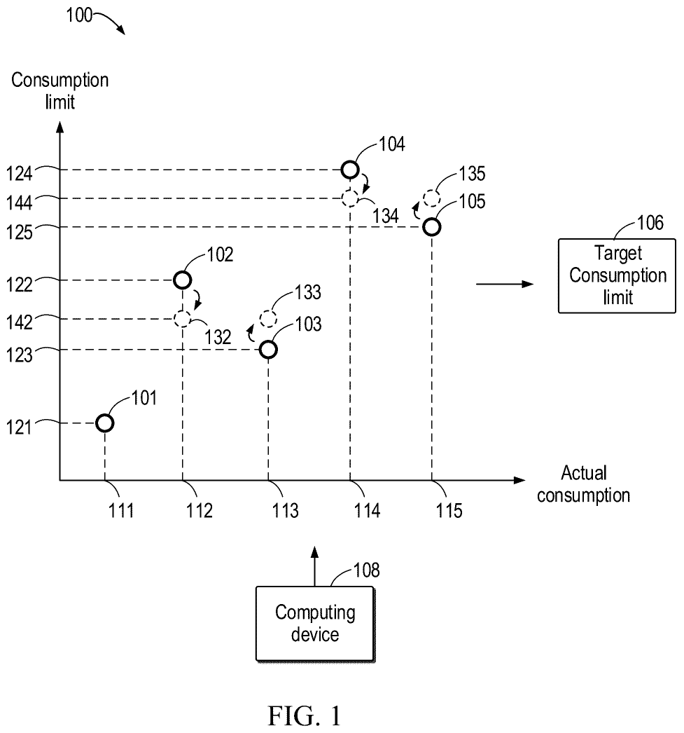

FIG. 1 illustrates an example environment 100 in which example embodiments of the present disclosure may be implemented. As shown in FIG. 1, the environment 100 includes a computing device 108. The computing device 108 may be any device having computing ability, such as a server, a personal computer, a laptop computer, a tablet, a smart telephone, a personal assistant, or a smart wearable device, etc. In the environment 100, a user may submit a request to place target information in an application. Then, the computing device 108 may obtain a plurality of pairs of consumption limits and actual consumptions within a period of time, for example, 10 minutes, 20 minutes, or 30 minutes, etc. The computing device 108 may determine a target consumption limit based on these pairs of consumption limits and actual consumptions.

In the environment 100, the computing device 108 may obtain a plurality of points 101, 102, 103, 104, and 105, indicating a plurality of pairs of consumption limits and actual consumptions in a past period of time. The point 101 indicates a consumption limit 121 and a corresponding actual consumption 111, the point 102 indicates a consumption limit 122 and a corresponding actual consumption 112, the point 103 indicates a consumption limit 123 and a corresponding actual consumption 113, the point 104 indicates a consumption limit 124 and a corresponding actual consumption 114, and the point 105 indicates a consumption limit 12 and a corresponding actual consumption 1115.

The points 101, 102, 103, 104, and 105 may be collected at multiple timestamps. For example, T0, T1, T2, T3, T4, and T5 are timestamps with a specific interval (e.g., 20 seconds). The point 105 may be obtained at T1, where the consumption limit 125 may indicate a consumption limit during a period of time between TO and T1, and the actual consumption 115 may indicate an actual consumption during this period of time. For example, the consumption limit 125 may be 6 resource units, and the actual consumption 115 may be 4 resource units.

In the environment 100, the computing device 108 may sort the plurality of pairs of consumption limits and actual consumptions by the actual consumptions in an increasing order. As shown in FIG. 1, the actual consumption 111 has the smallest value, and the actual consumption 115 has the largest value. In the environment 100, after sorted by the actual consumptions, the sequence of the consumption limits of these points is not a non-decreasing sequence, because the consumption limit 123 of the point 101 is less than the consumption limit 122 of the point 102, and the consumption limit 125 of the point 105 is less than the consumption limit 124 of the point 104.

In order to improve the accuracy of the determined target consumption limit, the client device 108 may determine a monotonic sequence based on the points 101, 102, 103, 104, and 105. Some traditional schemes determine a longest increasing subsequence from the points 101, 102, 103, 104, and 105. For example, the points 101, 103, and 105 is a longest increasing subsequence. Therefore, by discarding the points 102 and 104, the traditional schemes determine a target consumption limit based on the points 101, 103, and 105. However, the information contained in the points 102 and 104 is not utilized, resulting in low accuracy of the determined target consumption limit. In addition, beside the subsequence including the points 101, 103, and 105, there are other longest increasing subsequences in the points 101, 102, 103, 104, and 105. For example, another longest increasing subsequence may include the points 101, 102, and 104, resulting in low stability of the determined target consumption limit.

In the scheme provided by the embodiments of the present disclosure, the computing device 108 may adjust the consumption limits of these points, making the adjusted consumption limits to be monotonic. For example, the computing device 108 may adjust the consumption limit 122 of the point 102 and the consumption limit 123 of the point 103 to a consumption limit 142. In other words, the point 102 may be adjusted to a point 132, and the point 103 may be adjusted to a point 133. Furthermore, the computing device 108 may adjust the consumption limit 124 of the point 104 and the consumption limit 125 of the point 105 to a consumption limit 144. In other words, the point 104 may be adjusted to a point 134, and the point 105 may be adjusted to a point 135. Therefore, the sequence of points 101, 102, 103, 104, and 105 can be adjusted to a sequence of points 101, 132, 133, 134, and 135, and the sequence of points 101, 132, 133, 134, and 135 is a non-decreasing sequence.

In the environment 100, the computing device 108 may determine a target consumption limit 106 based on the points 101, 132, 133, 134, and 135. The target consumption limit 106 may be allocated for placing the target information in the application or platform. Furthermore, the target consumption limit 106 may satisfy an expected consumption set by the user, and the audience engagements associated with the target information can be maximized.

In this way, the target consumption limit can be determined in real-time based on the fresh data. Furthermore, by adjusting the pairs violating the monotonic property, all information indicated in the plurality of pairs of consumption limits and actual consumptions can be leveraged for determining the target consumption limit. Thus, the effective and the accuracy of the determined target consumption limit can be improved.

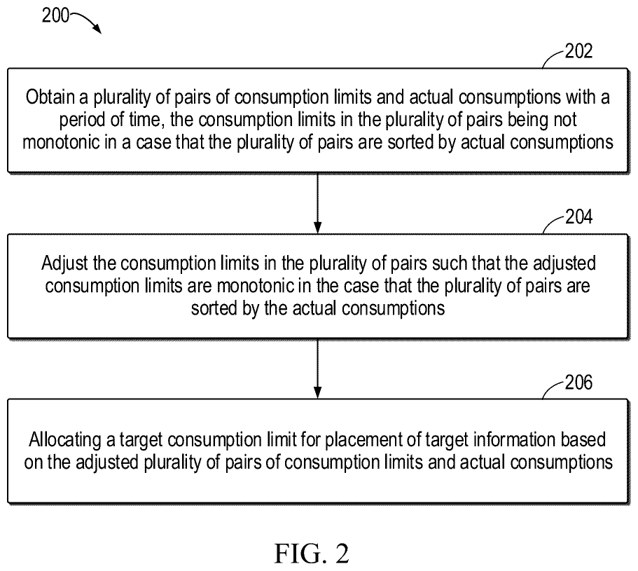

FIG. 2 is a flow chart illustrating an example process 200 of placing information according to some embodiments of the present disclosure. The example process 200 may be implemented by a computing device. For example, the computing device may be the computing device 108 in FIG. 1. As shown in FIG. 2, at block 202, the computing device may obtain a plurality of pairs of consumption limits and actual consumptions within a period of time, where the consumption limits in the plurality of pairs are not monotonic in a case that the plurality of pairs are sorted by actual consumptions. For example, as shown in FIG. 1, the computing device 108 may obtain a plurality of points 101, 102, 103, 104, and 105, indicating a plurality of pairs of consumption limits and actual consumptions in a past period of time. These points may be sorted by actual consumptions. The consumption limits of the sorted points are not monotonic, because the consumption limit 123 of the point 101 is less than the consumption limit 122 of the point 102, and the consumption limit 125 of the point 105 is less than the consumption limit 124 of the point 104.

At block 204, the computing device may adjust the consumption limits in the plurality of pairs such that the adjusted consumption limits are monotonic in the case that the plurality of pairs are sorted by the actual consumptions. For example, as shown in FIG. 1, the computing device 108 may adjust the consumption limits of the points 101, 102, 103, 104, and 105, making the adjusted consumption limits to be monotonic. For example, the computing device 108 may adjust the consumption limit 122 of the point 102 and the consumption limit 123 of the point 103 to a consumption limit 142. Furthermore, the computing device 108 may adjust the consumption limit 124 of the point 104 and the consumption limit 125 of the point 105 to a consumption limit 144. Therefore, the sequence of points 101, 102, 103, 104, and 105 can be adjusted to a sequence of points 101, 132, 133, 134, and 135, and the sequence of points 101, 132, 133, 134, and 135 is a non-decreasing sequence.

At block 206, the computing device may allocate a target consumption limit for placement of target information based on the adjusted plurality of pairs of consumption limits and actual consumptions. For example, as shown in FIG. 1, the computing device 108 may determine a target consumption limit 106 based on the points 101, 132, 133, 134, and 135. The target consumption limit may be allocated for placing the target information in the application or platform. Furthermore, the target consumption limit 106 may satisfy an expected consumption set by the user, and the audience engagements associated with the target information can be maximized.

In this way, the target consumption limit can be determined in real-time based on the fresh data. Furthermore, by adjusting the pairs violating the monotonic property, all information indicated in the plurality of pairs of consumption limits and actual consumptions can be leveraged for determining the target consumption limit. Thus, the effective and the accuracy of the determined target consumption limit can be improved.

In some implementations, in order to adjust the consumption limits in the plurality of pairs of consumption limits and actual consumptions, the plurality of pairs of consumption limits and actual consumptions may be sorted by the actual consumptions in increasing order. An adjacent pair of consumption limits including a first consumption limit and a second consumption limit in which the first consumption limit being greater than the second consumption limit may be determined. An updated consumption limit may be determined based on the first consumption limit and the second consumption limit. Then, the first consumption limit and the second consumption limit may be adjusted based on the updated consumption limit. In some implementations, an average of the first consumption limit and the second consumption limit may be determined as the updated consumption limit.

In some implementations, if it is determined that a third consumption limit next to the second consumption limit is greater than the updated consumption limit, the first consumption limit and the second consumption limit may be updated to the updated consumption limit. In some implementations, if it is determined that the third consumption limit next to the second consumption limit is less than the first updated consumption limit, a second updated consumption limit may be determined based on the first consumption limit, the second consumption limit, and the third consumption limit. Then, the first consumption limit, the second consumption limit, and the third consumption limit may be adjusted based on the second updated consumption limit.

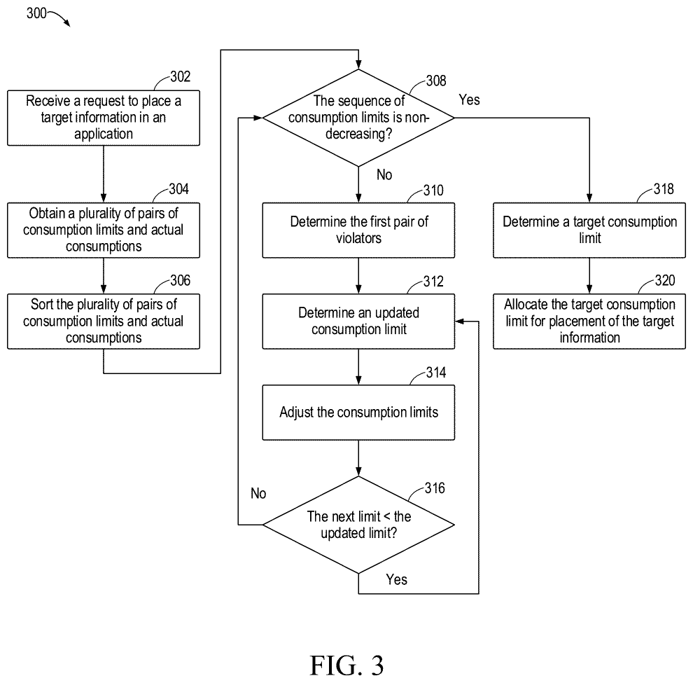

FIG. 3 is a flow chart illustrating another example process 300 of placing information according to some embodiments of the present disclosure. As shown in FIG. 3, at block 302, a computing device may receive a request to place a target information in an application. The request may include an expected consumption for the placement of the target information. For example, the computing device may receive a request to place the target information within the next 20 seconds, and the expected consumption limit within the next 20 seconds may be 6 resource units. Then, the computing device will determine a target consumption limit based on the expected consumption limit.

At block 304, after receiving the request to place the target information, the computing device may obtain a plurality of pairs of consumption limits and actual consumptions in a past period of time. The consumption limits in the plurality of pairs are not monotonic when the plurality of pairs are sorted by actual consumptions. In some implementations, the period of time is within a predetermined time range before the request is received. For example, when the computing device receives a request to place the target information, it may obtain the consumption limits and actual consumptions in the past 5 minutes (i.e., about 15-20 pairs of consumption limits and actual consumptions). In this way, the obtained data is fresh, thereby the accuracy of the determined target consumption limit can be improved.

At block 306, the computing device may sort the plurality of pairs of consumption limits and actual consumptions by the actual consumptions in increasing order. After sorting the plurality of pairs by the actual consumptions, the computer device may check whether the sorted sequence of the consumption limits is a non-decreasing sequence. At block 308, if the sorted sequence of the consumption limits is not a non-decreasing sequence, the process 300 may proceed to block 310.

At block 310, the computing device may determine the first pair of violators. Violators refer to consumption limits that are not non-decreasing. For example, the computing device may traverse the sorted sequence of the consumption limits from the smallest consumption limit, until it finds a consumption limit that is less than the previous consumption limit. Therefore, these two consumption limits are the first pair of violators.

At block 312, the computing device may determine an updated consumption limit based on the violators. In some implementations, the computing device may determine an average of the violators as the updated consumption limit. In some implementations, the violators may be assigned weights based on freshness of the data. Then, the computing device may determine a weighted average of the violators as the updated consumption limit. In some situations, if the computing device find multiple consecutive violators in the sorted sequence of the consumption limits, the computing device may determine a weighted average of the multiple violators as the updated consumption limits.

At block 314, the computing device may adjust the consumption limits of the violators. For example, the computing device may assign the updated consumption limit to these violators, such that the violators may have the same consumption limits. Therefore, the adjusted consumption limits are non-decreasing.

At block 316, the computing device may check whether the next consumption limit is less than the updated consumption limit. If the next consumption limit is less than the updated consumption limit, the process 300 may proceed to block 312. At block 312, the computing device may re-determine an updated consumption limit based on all the violators. If the next consumption is not less than the updated consumption limit, the process 300 may proceed to block 308.

Return back to block 308, if the adjusted sequence of consumption limits is non-decreasing, the process 300 may proceed to block 318. At block 318, the computing device may determine a target consumption limit based on the expected consumption and the adjusted plurality of pairs of consumption limits and actual consumptions. At block 320, the computing device may allocate the target consumption limit for placement of the target information.

In this way, the average time complexity of the adjustment algorithm is O(N). Compared to the average time complexity of the longest increasing subsequence (i.e., O(NlogN)), the performance of the process 300 can be improved. Therefore, the process 300 is lightweight and well-suited for online adjustments.

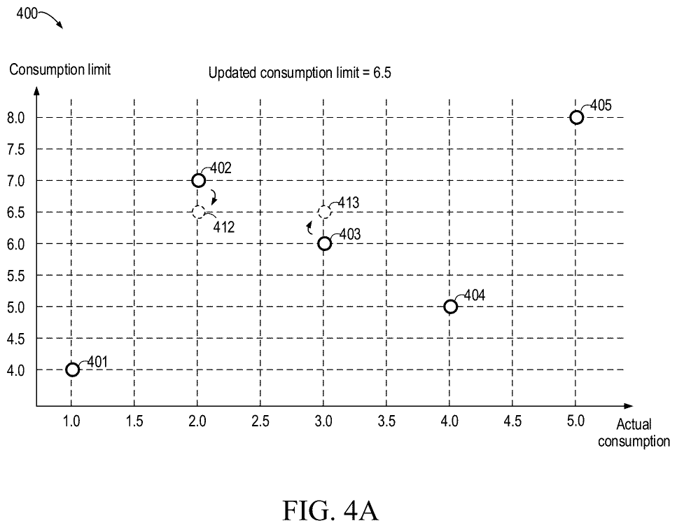

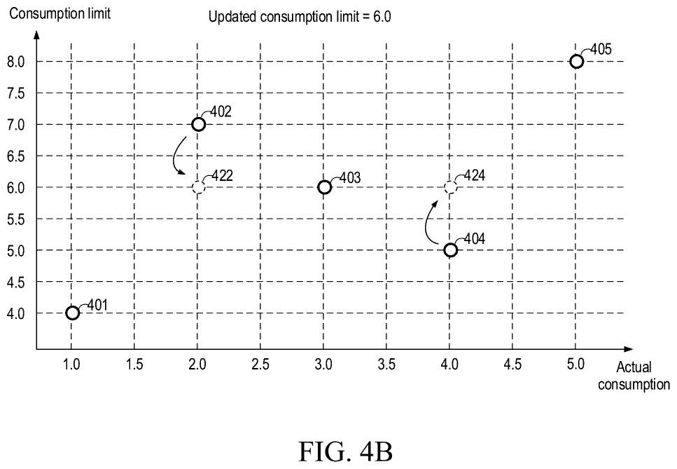

FIGS. 4A-4B are schematic diagrams illustrating an example 400 of adjusting a plurality of pairs of consumption limits and actual consumptions according to some embodiments of the present disclosure. As shown in FIG. 4A, the example 400 includes a plurality of pairs of consumption limits and actual consumptions in a past period time, i.e., points 401, 402, 403, 404, and 405. In the example 400, an actual consumption of the point 401 is 1.0, and a consumption limit of the point 401 is 4.0; an actual consumption of the point 402 is 2.0, and a consumption limit of the point 402 is 7.0; an actual consumption of the point 403 is 3.0, and a consumption limit of the point 403 is 6.0; an actual consumption of the point 404 is 4.0, and a consumption limit of the point 404 is 5.0; and an actual consumption of the point 405 is 5.0, and a consumption limit of the point 405 is 8.0. At the beginning of the adjustment, these points may be sorted by the actual consumptions in increasing order. Then, a computing device may traverse the points from left to right until it finds a consumption limit that is less than the previous consumption limit.

In the example 400, the first violation occurs at the point 402 and the point 403 because the consumption limit of the point 403 is less than the consumption limit of the point 402. Then, the computing device may determine an average of the consumption limit of the point 402 (i.e., 7.0) and the consumption limit of the point 403 (i.e., 6.0) as an updated consumption limit (i.e., 6.5). Then, the computing device may adjust the point 402 to a point 412, and adjust the point 403 to a point 413 based on the updated consumption limit. In this way, the point 412 and the point 413 can be non-decreasing.

After determining the updated consumption limit, the computing device may determine whether the point (i.e., the point 404) next to the point 403 is a violator by comparing the consumption limit of the next point with the updated consumption limit. In the example 400, the point 404 may be determined as another violator because its consumption limit (i.e., 5.0) is less than the updated consumption limit (i.e., 6.5). Then, the computing device may re-determine an updated consumption limit based on the points 402, 403, and 404.

As shown in FIG. 4B, the computing device may determine an average of the consumption limit of the point 402 (i.e., 7.0), the consumption limit of the point 403 (i.e., 6.0), and the consumption limit of the point 404 (i.e., 5.0) as a new updated consumption (i.e., 6.0). Then, the computing device may adjust the point 402 to a point 422, and adjust the point 404 to a point 424 based on the updated consumption limit. In this example, the point 403 is not adjusted because its consumption limit equals to the updated consumption limit. In this way, the points 402, 403, and 404 can be non-decreasing.

Then, the computing device may determine whether the point (i.e., the point 405) next to the point 404 is a violator by comparing the consumption limit of the next point with the new updated consumption limit. In the example 400, the point 405 may be determined as a non-violator because its consumption limit (i.e., 8.0) is not less than the new updated consumption limit (i.e., 6.0). In this way, the points 401, 402, 403, 404, and 405 can be adjusted to the points 401, 422, 403, 424, and 405, where the consumption limits of the adjusted points are non-decreasing.

In some implementations, when determining the updated consumption limit based on the first consumption limit and the second consumption limit, a plurality of freshness values corresponding to the plurality of pairs of consumption limits and actual consumptions may be determined. A plurality of weights may be assigned to the plurality of pairs of consumption limits and actual consumptions based on the plurality of freshness values. Then, the updated consumption limit may be determined based on the weighted first consumption limit and the weighted second consumption limit. In some implementations, a weighted average of the weighted first consumption limit and the weighted second consumption limit may be determined as the updated consumption limit.

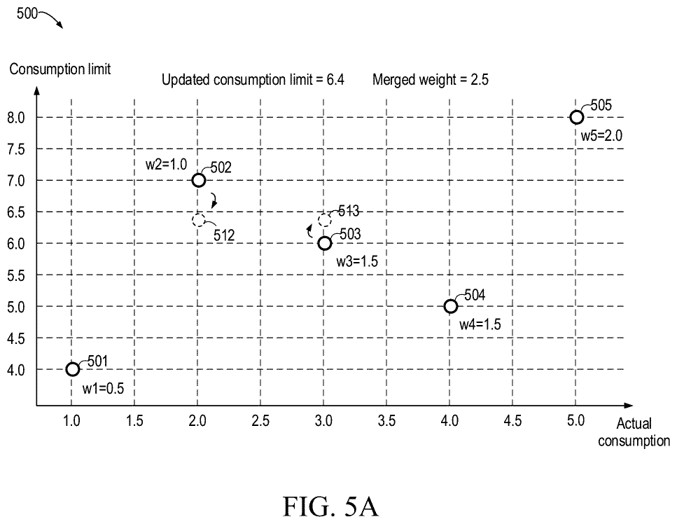

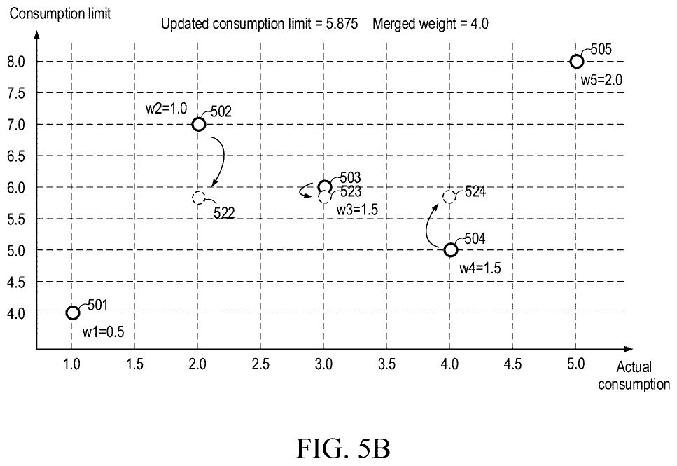

FIGS. 5A-5B are schematic diagrams illustrating an example 500 of adjusting a plurality of pairs of consumption limits and actual consumptions with weights according to some embodiments of the present disclosure. As shown in FIG. 5A, the example 500 includes a plurality of pairs of consumption limits and actual consumptions in a past period time, i.e., points 501, 502, 503, 504, and 505. In the example 500, an actual consumption of the point 501 is 1.0, and a consumption limit of the point 501 is 4.0; an actual consumption of the point 502 is 2.0, and a consumption limit of the point 502 is 7.0; an actual consumption of the point 503 is 3.0, and a consumption limit of the point 503 is 6.0; an actual consumption of the point 504 is 4.0, and a consumption limit of the point 504 is 5.0; and an actual consumption of the point 505 is 5.0, and a consumption limit of the point 505 is 8.0.

In addition, the computing device may determine freshness values corresponding to these points. In some implementations, if a timestamp of a first point is earlier than a timestamp of a second point, a freshness value of the first point may be less than a freshness value of the second point, indicating that the second point is fresher than the first point. Then, the computing device may assign a greater weight to the fresher point. The computing device may determine the updated consumption limit based on the weighted points.

In the example 500, assuming that the timestamp of the point 501 is T1, the timestamp of the point 502 is T2, the timestamp of the point 503 is T3, the timestamp of the point 504 is T4, and the timestamp of the point 505 is T5, where T1<T2<T3<T4<T5 (i.e., T1 is the earliest timestamp). Then, the computing device may assign a weight W1 (i.e., 0.5) to the point 501, assign a weight W2 (i.e., 1.0) to the point 502, assign a weight W3 (i.e., 1.5) to the point 503, assign a weight W4 (i.e., 1.5 as well) to the point 504, and assign a weight W5 (i.e., 2.0) to the point 505. At the beginning of the adjustment, these points may be sorted by the actual consumptions in increasing order. Then, a computing device may traverse the points from left to right until it finds a consumption limit that is less than the previous consumption limit.

In the example 500, the first violation occurs at the point 502 and the point 503 because the consumption limit of the point 503 is less than the consumption limit of the point 502. Then, the computing device may determine a weighted average of the consumption limit of the point 502 (i.e., 7.0) and the consumption limit of the point 503 (i.e., 6.0) as an updated consumption limit (i.e., (7.0*W2+6.0*W3)/(W2+W3)=6.4). In addition, the computing device may determine a merged weight for the updated consumption limit by calculating a sum of the W2 and W3 (i.e., 2.5). Then, the computing device may adjust the point 502 to a point 512, and adjust the point 03 to a point 513 based on the updated consumption limit. In this way, the point 512 and the point 513 can be non-decreasing.

After determining the updated consumption limit, the computing device may determine whether the point (i.e., the point 04) next to the point 03 is a violator by comparing the consumption limit of the next point with the updated consumption limit. In the example 500, the point 504 may be determined as another violator because its consumption limit (i.e., 5.0) is less than the updated consumption limit (i.e., 6.4). Then, the computing device may re-determine an updated consumption limit based on the previous updated consumption limit, the merged weight, the consumption limit of the point 504, and the weight of the point 504.

As shown in FIG. 5B, the computing device may determine a weighted average of the previous updated consumption limit (i.e., 6.4) and the consumption limit of the point 504 (i.e., 5.0) as a new updated consumption limit (i.e., (6.4*merged weight+5.0*W4)/(merged weight+W4)=(6.4*2.5+5.0*1.5)/(2.5+1.5)=5.875). In addition, the computing device may update the merged weight for the new updated consumption limit by calculating a sum of the previous merged weight and W4 (i.e., 4). Then, the computing device may adjust the point 502 to a point 522, adjust the point 503 to a point 523, and adjust the point 504 to a point 524 based on the new updated consumption limit. In this way, the points 502, 503, and 504 can be non-decreasing.

Then, the computing device may determine whether the point (i.e., the point 505) next to the point 504 is a violator by comparing the consumption limit of the next point with the new updated consumption limit. In the example 500, the point 505 may be determined as a non-violator because its consumption limit (i.e., 8.0) is not less than the new updated consumption limit (i.e., 5.875). In this way, the points 501, 02, 503, 504, and 505 can be adjusted to the points 501, 522, 503, 524, and 505, where the consumption limits of the adjusted points are non-decreasing.

In this way, by assigning weights to the points based on the freshness of data, the accuracy of the updated consumption limit can be improved, thereby the determined target consumption limit can be improved as well.

In some implementations, when allocating the target consumption limit for the placement of the target information based on the expected consumption and the adjusted plurality of pairs of consumption limits and actual consumptions, a fitting function of consumption limit and actual consumption may be determined based on the adjusted plurality of pairs of consumption limits and actual consumptions. The target consumption limit may be determined based on the expected consumption and the fitting function. The target consumption may be allocated for the placement of the target information. In some implementations, a piecewise linear function may be generated by performing interpolations on each adjacent pairs of consumption limit in the adjusted plurality of pairs of consumption limits and actual consumptions comprises. The piecewise linear function may be determined as the fitting function of consumption limit and actual consumption.

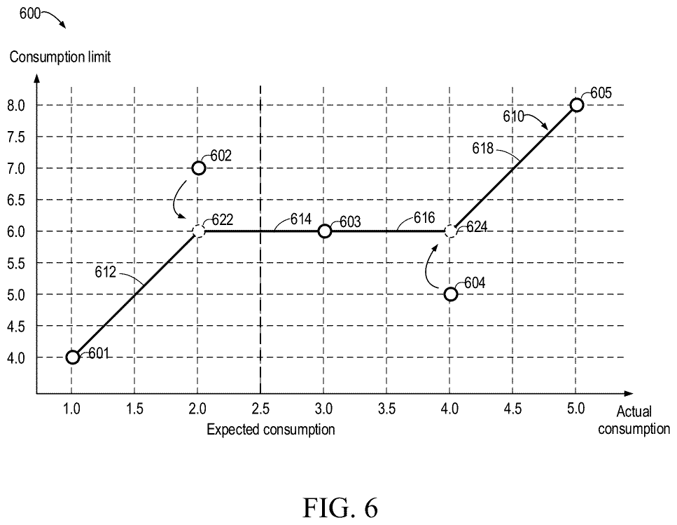

FIG. 6 is a schematic diagram illustrating an example 600 of generating a fitting function of consumption limit and actual consumption based on the adjusted plurality of pairs of consumption limits and actual consumptions according to some embodiments of the present disclosure. As shown in FIG. 6, the example 400 includes a plurality of pairs of consumption limits and actual consumptions in a past period time, i.e., points 601, 602, 603, 604, and 605. By applying the adjustment algorithm provided in the embodiments of the present disclosure, the point 602 is adjusted to the point 622, and the point 604 is adjusted to the point 624, such that the adjust points 601, 622, 603, 624, and 605 are non-decreasing.

In the example 600, the computing device may generate a segment 612 of a piecewise linear function 610 by performing an interpolation on the points 601 and 622. The computing device may also generate a segment 614 of the piecewise linear function 610 by performing an interpolation on the points 622 and 603. The computing device may also generate a segment 616 of the piecewise linear function 610 by performing an interpolation on the points 603 and 624. In addition, the computing device may also generate a segment 618 of the piecewise linear function 610 by performing an interpolation on the points 624 and 605. The piecewise linear function 610 may be determined as the fitting function of the points 601, 622, 603, 624, and 605.

In the example 600, the computing device may obtain the expected consumption (i.e., 2.5) from the received request to place the target information. Then, the computing device may determine the target consumption limit (i.e., 6.0) based on the expected consumption and the fitting function (i.e., the piecewise linear function 610). In this way, the fitting function can be generated by leveraging information of the points 601, 602, 603, 604, and 605 without discarding any points. Furthermore, the piecewise linear function 610 can better represent the plurality pairs of consumption limits and actual consumptions. Thus, the accuracy of the target consumption limit can be improved.

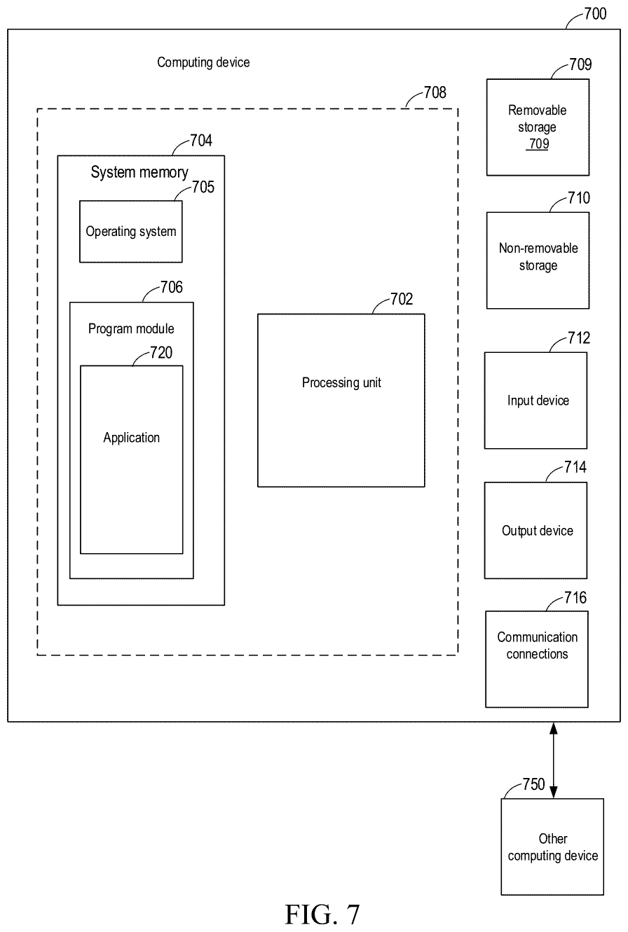

FIG. 7 is a block diagram illustrating physical components (e.g., hardware) of an electronic device 700 with which aspects of the disclosure may be practiced. For example, the electronic device 700 may implements the processes as depicted in FIGS. 1-6. In a basic configuration, the processing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories.

The system memory 704 may include an operating system 705 and one or more program modules 706 suitable for performing the various aspects disclosed herein such. The operating system 705, for example, may be suitable for controlling the operation of the processing device 700. Furthermore, aspects of the disclosure may be practiced in conjunction with other operating systems, or any other application program and is not limited to any particular application or system. This basic configuration is illustrated in FIG. 7 by those components within a dashed line 708. The processing device 700 may have additional features or functionality. For example, the processing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, several program modules and data files may be stored in the system memory 704. While executing on the at least one processing unit 702, an application 720 or program modules 706 may perform processes including, but not limited to, one or more aspects, as described herein. The application 720 may include an application interface 721 which may be the same as or similar to the application interface 721 as previously described in more detail with regard to FIGS. 1-6. Other program modules that may be used in accordance with aspects of the present disclosure may include electronic mail and contacts applications, word processing applications, spreadsheet applications, database applications, slide presentation applications, drawing or computer-aided application programs, etc., and/or one or more components supported by the systems described herein.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the processing device 500 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general-purpose computer or in any other circuits or systems.

The processing device 700 may also have one or more input device(s) 712 such as a keyboard, a mouse, a pen, a sound or voice input device, a touch or swipe input device, etc. The output device(s) 714 such as a display, speakers, a printer, etc. may also be included. The aforementioned devices are examples and others may be used. The processing device 700 may include one or more communication connections allowing communications with other computing or processing devices 750. Examples of suitable communication connections include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 904, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the processing device 700. Any such computer storage media may be part of the processing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The exemplary systems and methods of this disclosure have been described in relation to computing devices. However, to avoid unnecessarily obscuring the present disclosure, the preceding description omits several known structures and devices. This omission is not to be construed as a limitation. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

Several variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a non-transitory storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The disclosure is not limited to standards and protocols if described. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various configurations and aspects, includes components, methods, processes, systems and/or apparatus substantially as depicted and described herein, including various combinations, sub-combinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving case, and/or reducing cost of implementation.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A method for placing information, comprising:
obtaining a plurality of pairs of consumption limits and actual consumptions within a period of time, the consumption limits in the plurality of pairs being not monotonic in a case that the plurality of pairs are sorted by actual consumptions;
adjusting the consumption limits in the plurality of pairs such that the adjusted consumption limits are monotonic in the case that the plurality of pairs are sorted by the actual consumptions; and
allocating a target consumption limit for placement of target information based on the adjusted plurality of pairs of consumption limits and actual consumptions.

2. The method according to claim 1, wherein adjusting the consumption limits in the plurality of pairs such that the adjusted consumption limits are monotonic in the case that the plurality of pairs are sorted by the actual consumptions comprises:
sorting the plurality of pairs of consumption limits and actual consumptions by the actual consumptions in increasing order;
determining an adjacent pair of consumption limits including a first consumption limit and a second consumption limit in which the first consumption limit being greater than the second consumption limit;
determining an updated consumption limit based on the first consumption limit and the second consumption limit; and
adjusting the first consumption limit and the second consumption limit based on the updated consumption limit.

3. The method according to claim 2, wherein determining the updated consumption limit based on the first consumption limit and the second consumption limit comprises:
determining an average of the first consumption limit and the second consumption limit as the updated consumption limit.

4. The method according to claim 2, wherein determining the updated consumption limit based on the first consumption limit and the second consumption limit comprises:
determining a plurality of freshness values corresponding to the plurality of pairs of consumption limits and actual consumptions;
assigning a plurality of weights to the plurality of pairs of consumption limits and actual consumptions based on the plurality of freshness values; and
determining the updated consumption limit based on the weighted first consumption limit and the weighted second consumption limit.

5. The method according to claim 4, wherein determining the updated consumption limit based on the weighted first consumption limit and the weighted second consumption limit comprises:
determining a weighted average of the weighted first consumption limit and the weighted second consumption limit as the updated consumption limit.

6. The method according to claim 2, wherein adjusting the first consumption limit and the second consumption limit based on the updated consumption limit comprises:
determining that a third consumption limit next to the second consumption limit is greater than the updated consumption limit; and
updating the first consumption limit and the second consumption limit to the updated consumption limit.

7. The method according to claim 6, wherein the updated consumption limit is a first updated consumption limit, and adjusting the first consumption limit and the second consumption limit based on the updated consumption limit comprises:
determining that the third consumption limit next to the second consumption limit is less than the first updated consumption limit;
determining a second updated consumption based on the first consumption limit, the second consumption limit, and the third consumption limit; and
adjusting the first consumption limit, the second consumption limit, and the third consumption limit based on the second updated consumption limit.

8. The method according to claim 1, wherein allocating the target consumption limit for the placement of the target information based on the adjusted plurality of pairs of consumption limits and actual consumptions comprises:
receiving a request to place the target information in an application before obtaining the plurality of pairs of consumption limits and actual consumptions within the period of time, the period of time being within a predetermined time range before the request is received, the request comprising an expected consumption for the placement of the target information; and
allocating the target consumption limit for the placement of the target information based on the expected consumption and the adjusted plurality of pairs of consumption limit and actual consumption.

9. The method according to claim 8, wherein allocating the target consumption limit for the placement of the target information based on the expected consumption and the adjusted plurality of pairs of consumption limits and actual consumptions comprises:
generating a fitting function of consumption limit and actual consumption based on the adjusted plurality of pairs of consumption limits and actual consumptions;
determining the target consumption limit based on the expected consumption and the fitting function; and
allocating the target consumption for the placement of the target information.

10. The method according to claim 9, wherein generating the fitting function of consumption limit and actual consumption based on the adjusted plurality of pairs of consumption limits and actual consumptions comprises:
generating a piecewise linear function by performing interpolations on each adjacent pairs of consumption limit in the adjusted plurality of pairs of consumption limits and actual consumptions comprises; and
determining the piecewise linear function as the fitting function of consumption limit and actual consumption.

11. An electronic device, comprising:
a memory and a processor;
wherein the memory is configured to store one or more computer instructions which, when executed by the processor, cause the processor to:
obtain a plurality of pairs of consumption limits and actual consumptions within a period of time, the consumption limits in the plurality of pairs being not monotonic in a case that the plurality of pairs are sorted by actual consumptions;
adjust the consumption limits in the plurality of pairs such that the adjusted consumption limits are monotonic in the case that the plurality of pairs are sorted by the actual consumptions; and
allocate a target consumption limit for placement of target information based on the adjusted plurality of pairs of consumption limits and actual consumptions.

12. The device according to claim 11, wherein the instructions causing the processor to adjust the consumption limits in the plurality of pairs such that the adjusted consumption limits are monotonic in the case that the plurality of pairs are sorted by the actual consumptions comprise instructions causing the processor to:
sort the plurality of pairs of consumption limits and actual consumptions by the actual consumptions in increasing order;
determine an adjacent pair of consumption limits including a first consumption limit and a second consumption limit in which the first consumption limit being greater than the second consumption limit;
determine an updated consumption limit based on the first consumption limit and the second consumption limit; and
adjust the first consumption limit and the second consumption limit based on the updated consumption limit.

13. The device according to claim 12, wherein the instructions causing the processor to determine the updated consumption limit based on the first consumption limit and the second consumption limit comprise instructions causing the processor to:
determine an average of the first consumption limit and the second consumption limit as the updated consumption limit.

14. The device according to claim 12, wherein the instructions causing determining the updated consumption limit based on the first consumption limit and the second consumption limit comprise instructions causing the processor to:
determine a plurality of freshness values corresponding to the plurality of pairs of consumption limits and actual consumptions;
assign a plurality of weights to the plurality of pairs of consumption limits and actual consumptions based on the plurality of freshness values; and
determine the updated consumption limit based on the weighted first consumption limit and the weighted second consumption limit.

15. The device according to claim 14, wherein the instructions causing the processor to determine the updated consumption limit based on the weighted first consumption limit and the weighted second consumption limit comprise instructions causing the processor to:
determine a weighted average of the weighted first consumption limit and the weighted second consumption limit as the updated consumption limit.

16. The device according to claim 12, wherein the instructions causing the processor to adjust the first consumption limit and the second consumption limit based on the updated consumption limit comprise instructions causing the processor to:
determine that a third consumption limit next to the second consumption limit is greater than the updated consumption limit; and
update the first consumption limit and the second consumption limit to the updated consumption limit.

17. The device according to claim 16, wherein the updated consumption limit is a first updated consumption limit, and the instructions causing the processor to adjust the first consumption limit and the second consumption limit based on the updated consumption limit comprise instructions causing the processor to:
determine that the third consumption limit next to the second consumption limit is less than the first updated consumption limit;
determine a second updated consumption based on the first consumption limit, the second consumption limit, and the third consumption limit; and
adjust the first consumption limit, the second consumption limit, and the third consumption limit based on the second updated consumption limit.

18. The device according to claim 11, wherein the instructions causing the processor to allocate the target consumption limit for the placement of the target information based on the adjusted plurality of pairs of consumption limits and actual consumptions comprise instructions causing the processor to:
receive a request to place the target information in an application before obtaining the plurality of pairs of consumption limits and actual consumptions within the period of time, the period of time being within a predetermined time range before the request is received, the request comprising an expected consumption for the placement of the target information; and
allocate the target consumption limit for the placement of the target information based on the expected consumption and the adjusted plurality of pairs of consumption limit and actual consumption.

19. The device according to claim 18, wherein the instructions causing the processor to allocate the target consumption limit for the placement of the target information based on the expected consumption and the adjusted plurality of pairs of consumption limits and actual consumptions comprise instructions causing the processor to:
generate a fitting function of consumption limit and actual consumption based on the adjusted plurality of pairs of consumption limits and actual consumptions;
determine the target consumption limit based on the expected consumption and the fitting function; and
allocate the target consumption for the placement of the target information.

20. A non-transitory computer-readable medium comprising instructions stored thereon which, when executed by a processor, cause the processor to:
obtain a plurality of pairs of consumption limits and actual consumptions within a period of time, the consumption limits in the plurality of pairs being not monotonic in a case that the plurality of pairs are sorted by actual consumptions;
adjust the consumption limits in the plurality of pairs such that the adjusted consumption limits are monotonic in the case that the plurality of pairs are sorted by the actual consumptions; and
allocate a target consumption limit for placement of target information based on the adjusted plurality of pairs of consumption limits and actual consumptions.
